(19) United States
(12) Patent Application Publication
(10) Pub. No.: US 2015/0309384 A1
(43) Pub. Date: Oct. 29, 2015

(54) COLOR FILTER SUBSTRATE AND METHOD OF MANUFACTURING THE SAME, AND DISPLAY DEVICE

(71) Applicants: BOE Technology Group Co., Ltd., Beijing (CN); Beijing BOE Display Technology Co., Ltd., Beijing (CN)

(72) Inventors: Sikai Zhang, Beijing (CN); Jiyu Wan, Beijing (CN); He Feng, Beijing (CN)

(21) Appl. No.: 14/446,851

(22) Filed: Jul. 30, 2014

(30) Foreign Application Priority Data
Apr. 28, 2014 (CN) 201410175525.9

(51) Int. Cl. G02F 1/167; G02F 1/1335; G02F 1/1368; G02B 5/20

(52) U.S. Cl. CPC G02F 1/167; G02B 5/201; G02F 1/133516; G02F 1/1368; G02F 2001/133519

(57) ABSTRACT

The present invention relates to a color filter substrate and a method of manufacturing the same and a display device. In the color filter substrate according to the present invention, the color filter layer is directly formed on the glass substrate where the pixel electrodes for controlling display of electronic ink are located, or, the glass substrate for forming the color filter layer thereon is directly superposed on the glass substrate where the pixel electrodes for controlling the displaying of the electronic ink are located. In this way, compared with that the case in which the whole liquid crystal display panel and the whole electronic ink display panel are directly jointed together, the display panel in which the color filter substrate according to the present invention is used can greatly simplify a structure of the display device and reduce the thickness of the display device. On the other hand, since a projection of a location where the electronic ink is filled and that of locations of the color filters in the color filter layer in a plane perpendicular to the direction in which the first glass substrate and the second glass substrate are superposed are interlaced, an interference between the color display and the electronic ink display can be avoided or reduced.

### CROSS-REFERENCE TO RELATED APPLICATION

This application claims the benefit of the Chinese Patent Application No. 201410175525.9 filed on Apr. 28, 2014 in the State Intellectual Property Office of China, the whole disclosure of which is incorporated herein by reference.

### BACKGROUND OF THE INVENTION

1. Field of the invention

Embodiments of the present invention generally relate to a field of display technology, and more particularly, to a color filter substrate and a method of manufacturing the same and a display device.

2. Description of the Related Art

With the development of science and technology nowadays, the display technology upgrades continuously in order to meet people's different requirements. Currently, mainstream display technologies include liquid crystal display technology, organic light emitting diode (OLED) display technology, and electronic ink (E-ink) display technology. The three kinds of display technologies have respective different advantages and applicable display fields. For example, E-ink technology in which electronic ink acts as a key display component is mainly applied in the e-book field.

Electronic ink is a suspension system in which countless transparent microcapsules whose capsule cores consist of pigment particles and a solution are suspended in a transparent base solution. Currently, mainly used pigment particles comprise electronegative black particles and electropositive white particles. Under action of an applied electrical field, black particles and white particles move toward different directions based on a direction of the electrical field, so as to display a pattern checkered with black and white.

Electronic ink has many advantages including legibility, ease and cheapness of manufacturing, low power consumption, and high reflectivity and contrast. It can maintain a still image for several weeks without consuming any additional electric energy.

Since electronic ink is only used to display black and white images, a conventional dual display device is proposed to achieve displaying of color images while obtaining the abovementioned advantages of the electronic ink.

In the conventional dual display device, electronic ink display panel and liquid crystal display panel are irrelevant with each other but are simply jointed together, thereby resulting in a complicated structure and a relatively large thickness of the display device.

### SUMMARY OF THE INVENTION

In order to overcome or eliminate at least one of the above-mentioned and other problems, at least one object of the present invention is to provide a dual display device which has a simple structure and a relatively small thickness.

According to one aspect of the present invention, there is provided a color filter substrate, comprising:

first and second glass substrates superposed on each other, the second glass substrate having a first surface facing the first glass substrate and a second surface opposite from the first surface;

a common electrode layer formed on a surface of the first glass substrate facing the second glass substrate;

a pixel electrode layer formed on the first surface of the second glass substrate and comprising a plurality of pixel electrodes spaced from one another; and

a color filter layer formed on the second surface of the second glass substrate and comprising a plurality of color filters with a void region therebetween,

wherein a projection of a pattern formed of said plurality of pixel electrodes in a plane perpendicular to a direction in which the first glass substrate and the second glass substrate are superposed is within a projection of the void region in the plane, and

electronic ink is filled at least between the common electrode layer and each of the pixel electrodes, and a projection of a region where the electronic ink is filled in the plane is within a projection of the void region in the plane.

According to another aspect of the present invention, there is provided a method of manufacturing a color filter substrate, comprising the following steps of:

providing a first glass substrate and forming a pattern of a common electrode layer on a surface of the first glass substrate;

providing a second glass substrate and forming a pattern of a color filter layer on a first surface of the second glass substrate, said color filter layer comprising a plurality of color filters with a void region therebetween;

forming a pattern of a plurality of pixel electrodes spaced from one another on a second surface of the second glass substrate opposite from the first surface such that a projection of the pattern of said plurality of pixel electrodes in a plane where said second surface is located is within a projection of the void region in the plane; and

forming, after forming the pattern of the plurality of pixel electrodes, a transparent photoresist pattern on the second surface of the second glass substrate, wherein said transparent photoresist pattern includes a plurality of transparent photoresist elements and a groove region between said plurality of transparent photoresist elements, and, a projection of the groove region in the plane is within or is fully overlapped with a projection of said void region in the plane;

filling, after forming the transparent photoresist pattern, said groove region with electronic ink; and

assembling, after filling of the electronic ink, the first glass substrate and the second glass substrate in such a manner that the surface of the first glass substrate formed with the common electrode layer seals and covers the electronic ink on the second glass substrate.

According to still another aspect of the present invention, there is provided a display device comprising the above-mentioned color filter substrate.

In the color filter substrate according to the present invention, the color filter layer is directly formed on the glass substrate where the pixel electrodes for controlling the displaying of the electronic ink are located, or, the glass substrate for forming the color filter layer thereon is directly superposed on the glass substrate where the pixel electrodes for controlling the displaying of the electronic ink are located. In this way, compared with a case in which the whole liquid crystal display panel and the whole electronic ink display panel are directly jointed together, the display panel in which the color filter substrate according to the present invention is used can greatly simplify a structure of the display device and reduce the thickness of the display device. On the other hand, since a projection of a location where the electronic ink is filled and that of locations of the color filters in the color filter layer on a plane perpendicular to the direction in which the first glass substrate and the second glass substrate are superposed are interlaced or not overlapped with each other, an interference between the color display and the electronic ink display can be avoided or reduced.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic diagram of a color filter substrate according to a first embodiment of the present invention; and

FIG. 2 is a schematic diagram of a color filter substrate according to a second embodiment of the present invention.

### DETAILED DESCRIPTION OF PREFERRED EMBODIMENTS OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### First Embodiment

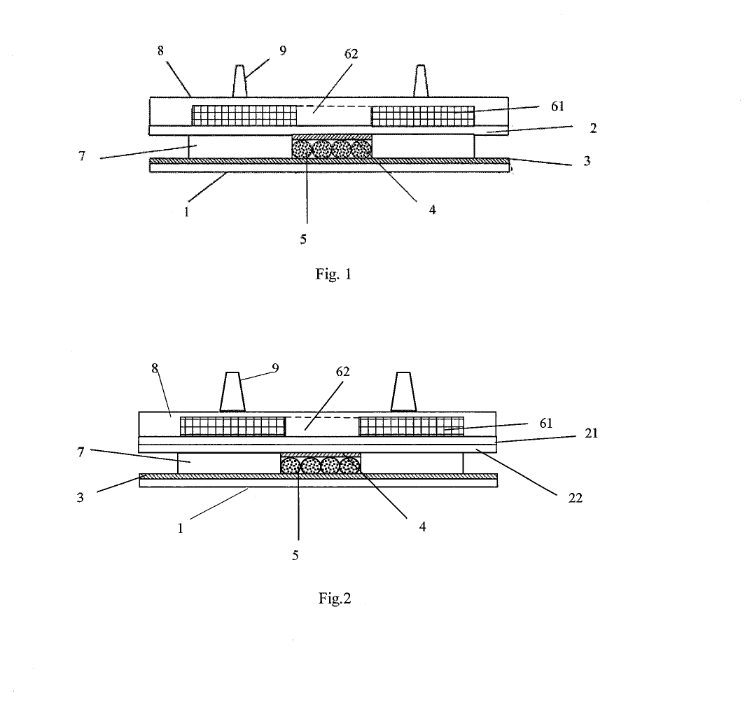

Referring to FIG. 1, a color filter substrate according to a first embodiment of the present invention comprises a first glass substrate 1 and a second glass substrate 2 superposed on each other, the second glass substrate 2 having a first surface (e.g., a lower surface of the second glass substrate 2 as shown in the figure) facing the first glass substrate 1 and a second surface (e.g., an upper surface of the second glass substrate 2 as shown in the figure) opposite from the first surface; a common electrode layer 3 formed on a surface (e.g., a lower surface of the first glass substrate 1 as shown in the figure) of the first glass substrate facing the second glass substrate; a pixel electrode layer formed on the first surface of the second glass substrate 2 facing the first glass substrate 1 and comprising a plurality of pixel electrodes 4 spaced from one another; and a color filter layer formed on the second surface of the second glass substrate 2 and comprising a plurality of color filters 61 with a void region 62 among the color filters 61.

In the above color filter substrate, a projection of a pattern formed by the plurality of pixel electrodes 4 in a plane perpendicular to a direction in which the first glass substrate 1 and the second glass substrate 2 are superposed are within a projection of the void region 62 in the plane. Further, electronic ink 5 is filled at least between the common electrode layer and each of the pixel electrodes, and, a projection of a region where the electronic ink 5 is filled in the plane is within a projection of the void region 62 in the plane.

It can be understood that, a difference between the pattern formed by these pixel electrodes 4 and the pattern of the void region 62 between the color filters 61 is in that these pixel electrodes 4 are spaced from each other in order to achieve on-and-off controls of these pixel electrodes 4 respectively. The projection of the pattern formed by these pixel electrodes 4 on the above-mentioned plane is within the projection of the void region 62 between the color filters 61 in the plane in order to avoid interference to the color display.

It can also be understood that, the color filters may be red color filters, blue color filters and green color filters for transmitting red light, blue light and green light, respectively; the pixel electrodes mentioned herein are electrodes for controlling the displaying of the electronic ink. The abovementioned color filter substrate may further comprise a plurality of switch units (e.g., thin film transistor switches, not shown) configured to control on and off of these pixel electrodes 4. For example, these switch units may be formed on a surface (i.e., the first surface) of the second glass substrate 2 facing the first glass substrate 1.

In the present embodiment, since a projection of a location or region where the electronic ink is filled and that of locations of the color filters in the color filter layer in the plane perpendicular to the direction in which the first glass substrate and the second glass substrate are superposed are interlaced or not overlapped with each other, color light will not be blocked by the electronic ink during the color display. Further, during an E-ink display, a backlight source is switched off, and a portion of the display device corresponding to location where no electronic ink is filled cannot reflect the external light and thus form a black display. Furthermore, the pixel electrodes can be controlled to allow the electronic ink in the display device to become black or white according to display requirements, such that a white pattern can be formed on a black display screen, thereby achieving the E-ink display. Therefore, the color filter substrate according to the present invention meets various display requirements in different occasions.

In addition, in the present embodiment, since the color filter layer is directly formed on the glass substrate on which the pixel electrodes for controlling the displaying of the electronic ink are located, the display panel in which the color filter substrate according to the present invention is used can greatly simplify the structure of the display device and reduce the thickness of the display device, compared with a case in which the whole liquid crystal display panel and the whole electronic ink display panel are directly jointed together.

In the conventional liquid crystal panels, a black matrix is provided between color filters in order to enhance the contrast. In the embodiment according to the present invention, since no black matrix is provided in the void region between these color filters and thus these color filters can be formed directly on the surface of the glass substrate, an angular section difference between the color filters (i.e., a certain height difference between an edge height and a central height of the color filters, caused by overlapping of the edges of the color filters with the black matrix) is reduced, thereby avoiding defective products caused by excessive angular section difference and increasing yield of products. Further, during a practical color display, the black pigment particles of the electronic ink are moved toward an observer to form a black matrix pattern when being applied with corresponding voltages, thereby enhancing the contrast between primary colors. Therefore, the color filter substrate according to the embodiment of the present invention not only satisfies the requirements of the dual display but also avoid use of the black matrix between these color filters, thereby reducing the cost of materials and process.

In an alternative embodiment of the present invention, as shown in FIG. 1, a plurality of transparent photoresist elements 7 may be provided between the first glass substrate 1 and the second glass substrate 2, and each transparent photoresist element is overlapped with a corresponding one of the color filters 61 in an one-to-one correspondence manner in the direction in which the first glass substrate 1 and the second glass substrate 2 are superposed with each other. For example, the plurality of transparent photoresist elements 7 can be formed on a surface (the lower surface shown in the Figure) of the second glass substrate 2 on which the pixel electrodes 4 are formed, and, sizes and locations of the transparent photoresist elements 7 correspond to these color filters 61 of the color filter layer, respectively, that is, are overlapped in the direction in which the first glass substrate 1 and the second glass substrate 2 are superposed with each other.

Herein, the electronic ink 5 is filled between these transparent photoresist elements 7. As such, no electronic ink 5 flows to other regions than regions between these transparent photoresist elements 7, so that the manufacturing process can be simplified, the filling of the electronic ink 5 is facilitated, and the electronic ink 5 needs not to be filled on the whole surface, thereby reducing consumption of electronic ink. It can be understood by those skilled in the art that, in practical applications, the electronic ink 5 may be only filled between pixel electrodes and the common electrode by other suitable manners. For example, a transparent film tube is provided between each pixel electrode and the common electrode, and the electronic ink is filled into the transparent film tube. However, the present invention is not limited to the above mentioned embodiments.

Provision of the plurality of separated transparent photoresist elements between the first glass substrate and the second glass substrate not only ensures the normal light transmission displaying, but also provides a space or groove between these transparent photoresist elements used as a filling space for the electronic ink, thereby easing the filling of the electronic ink and decreasing consumption of electronic ink.

In an alternative embodiment of the present invention, the electronic ink 5 may be filled between these adjacent transparent photoresist elements 7 by an inkjet technology.

In an alternative embodiment of the present invention, the transparent photoresist elements 7 mentioned herein may comprise transparent photoresist.

In an alternative embodiment of the present invention, as shown in FIG. 1, an outer coating 8 may be coated on a surface of the second glass substrate 2 formed with the color filter layer so as to protect the color filter layer.

In an alternative embodiment of the present invention, the outer coating 8 may comprise a wear-resisting layer of high hardness. Accordingly, it can prevent the color filter layer from being damaged when forming the pixel electrodes on the second glass substrate, thereby increasing yield of the display device.

In an alternative embodiment of the present invention, spacers 9 can be formed on the outer coating 8.

According to an exemplary embodiment of the present invention, there is provided a method of manufacturing a color filter substrate, comprising the following steps:

Step S1 of providing a first glass substrate and forming a pattern of a common electrode layer on a surface of the first glass substrate;

Step S2 of providing a second glass substrate and forming a pattern of a color filter layer on a first surface of the second glass substrate, said color filter layer comprising a plurality of color filters with a void region therebetween;

Step S3 of forming a pattern of a plurality of pixel electrodes spaced from one another on a second surface of the second glass substrate opposite from the first surface such that a projection of the pattern of said plurality of pixel electrodes in a plane where said second surface is located is within a projection of the void region in the plane;

Step S4 of forming, after forming the pattern of the pixel electrodes, a transparent photoresist pattern on the second surface of the second glass substrate, wherein said transparent photoresist pattern includes a plurality of transparent photoresist elements and a groove region between said plurality of transparent photoresist elements, a projection of each transparent photoresist element in the plane is overlapped with that of a corresponding color filter in the plane, and, a projection of the groove region in the plane is within a projection of the void region in the plane. It can be understood that the projection of the groove region in the plane can be fully overlapped with the projection of the void region in the plane, that is, the size and area of the projection of the groove region in the plane may be equal to the size and area of the projection of the void region in the plane;

Step S5 of filling, after forming the transparent photoresist pattern, said groove region with electronic ink;

Step S6 of assembling, after filling of the electronic ink, the first glass substrate and the second glass substrate in such a manner that the surface of the first glass substrate formed with the common electrode layer seals and covers the electronic ink on the second glass substrate. For example, the electronic ink may be filled between common electrode layer and each of the pixel electrodes.

It can be understood that, in the practical manufacturing process, it is not necessary that the step S1 is performed prior to the step S2, as long as the step S1 is performed before the step S6. Correspondingly, the step S2 and the step S3 may be performed in a reversed sequence. Further, the two opposite surfaces of the glass substrate are usually paralleled with each other, that is, the first surface of the second glass substrate is usually parallel with the second surface of the second glass substrate. Accordingly, the direction perpendicular to the second surface can also be the direction perpendicular to the first surface. Furthermore, it can be understood that the direction perpendicular to the first or second surface is the same as or is coincided with the abovementioned direction in which the first glass substrate and the second glass substrate are superposed.

It should be noted that, in the manufacturing method according to the abovementioned embodiment, these transparent photoresist elements are formed on the second glass substrate, and the electronic ink filled between these transparent photoresist elements on the second glass substrate is sealed and covered with the surface of the first glass substrate formed with the common electrode layer. However, in an alternative embodiment, these transparent photoresist elements can be formed on the first glass substrate, and the electronic ink filled between these transparent photoresist elements is sealed and covered with the pixel electrodes formed on the second glass substrate. In another alternative embodiment, these transparent photoresist elements can be formed on the first or the second glass substrate, and the electronic ink can be filled between these transparent photoresist elements after superposing the two glass substrates together.

In the abovementioned method, the step of forming the pattern of the plurality of pixel electrodes spaced from one another may further comprise forming a plurality of switch units configured to control on and off of the plurality of pixel electrodes. Alternatively, each switch unit may comprise a thin film transistor.

In an alternative embodiment of the present invention, after the step S2, the method may further comprise coating an outer coating on the pattern of the color filter layer.

Moreover, after coating the outer coating on the pattern of the color filter layer, the method may further comprise forming spacers on said outer coating.

### Second Embodiment

A color filter substrate according to the second embodiment of the present invention is generally the same as that according to the first embodiment, except for the following differences. Referring to FIG. 2, the second glass substrate is formed by jointing or superposing upper and lower glass substrates 21 and 22, wherein a lower surface (i.e., a third surface) of the upper glass substrate 21 is jointed to an upper surface (i.e., a fourth surface) of the lower glass substrate 22, and, the color filter layer is formed on the upper surface (i.e., the abovementioned second surface) of the upper glass substrate 21 and the pixel electrode layer 4 is formed on the lower surface (i.e., the abovementioned first surface) of the lower glass substrate 22. In this way, the electronic ink side substrate and the color filter side substrate can be manufactured separately so that adverse effects brought by friction occurring during the manufacturing process can be avoided.

In this embodiment of the present invention, since a projection of a location or region where the electronic ink is filled and that of locations of the color filters in the color filter layer in the plane perpendicular to the direction in which the first glass substrate and the second glass substrate are superposed are interlaced or not overlapped with each other, color light will not be blocked by the electronic ink during the color display.

Further, during an E-ink display, a backlight source is switched off, and a portion of the display device corresponding to location where no electronic ink is filled cannot reflect the external light and thus form a black display. Furthermore, the pixel electrodes can be controlled to allow the electronic ink in the display device to become black or white according to display requirements, such that a white pattern can be formed on a black display screen, thereby achieving the E-ink display. Therefore, the color filter substrate according to the present invention meets various display requirements in different occasions.

In addition, in the present embodiment, since the color filter layer is directly formed on the glass substrate on which the pixel electrodes for controlling the displaying of the electronic ink are located, the display panel in which the color filter substrate according to the present invention is used can greatly simplify the structure of the display device and reduce the thickness of the display device, compared with a case in which the whole liquid crystal display panel and the whole electronic ink display panel are directly jointed together.

A method of manufacturing a color filter substrate according to the second embodiment is generally the same as that according to the first embodiment of the present invention, except for the following differences.

The abovementioned step S2 is replaced by a step S2 in which a color filter layer is formed on the upper surface of the upper glass substrate. The abovementioned step S3 is replaced by a step S3′ in which the pattern of the color filter layer is formed on the lower surface of the lower glass substrate.

It can be understood that after the step S6 (i.e., after forming corresponding patterns on the first surface and the second surface), the method may further comprise a step S7 of superposing the upper glass substrate with the lower glass substrate such that the lower surface of the upper glass substrate and the upper surface of the lower glass substrate are joined together to form the second glass substrate. In this way, the electronic ink side substrate and the color filter side substrate can be manufactured separately so that the adverse effects brought by the friction occurring during the manufacturing process can be avoided. It can be understood that the step S7 may be performed prior to the step S5 as long as the friction occurring between the electronic ink side and the color filter side can be reduced during manufacturing.

Embodiments of the present invention further provide a display device comprising the abovementioned color filter substrate.

The display device according to the present invention may be various products or parts with a display function, including an electronic paper, a mobile phone, a tablet computer, TV, a display, a notebook computer, a digit photo frame, a navigator, etc. Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A color filter substrate comprising:
first and second glass substrates superposed on each other, the second glass substrate having a first surface facing the first glass substrate and a second surface opposite from the first surface;
a common electrode layer formed on a surface of the first glass substrate facing the second glass substrate;
a pixel electrode layer formed on the first surface of the second glass substrate and comprising a plurality of pixel electrodes spaced from one another; and
a color filter layer formed on the second surface of the second glass substrate and comprising a plurality of color filters with a void region therebetween,
wherein a projection of a pattern formed of said plurality of pixel electrodes in a plane perpendicular to a direction in which the first glass substrate and the second glass substrate are superposed is within a projection of the void region in the plane, and
electronic ink is filled at least between the common electrode layer and each of the pixel electrodes, and a projection of a region where the electronic ink is filled in the plane is within a projection of the void region in the plane.

2. The color filter substrate according to claim 1, further comprising a plurality of transparent photoresist elements formed between the first glass substrate and the second glass substrate and each overlapped with a corresponding one of the color filters in said direction in an one-to-one correspondence manner.

3. The color filter substrate according to claim 2, wherein said electronic ink is filled between these adjacent transparent photoresist elements by an inkjet technology.

4. The color filter substrate according to claim 2, wherein said transparent photoresist elements comprise transparent photoresist.

5. The color filter substrate according to claim 1, further comprising an outer coating coated on a surface of said second glass substrate formed with the color filter layer.

6. The color filter substrate according to claim 5, wherein said outer coating comprises a wear-resisting layer of high hardness.

7. The color filter substrate according to claim 1, wherein said second glass substrate comprises an upper glass substrate and a lower glass substrate superposed on each other, a lower surface of the upper glass substrate is attached to an upper surface of the lower glass substrate, said color filter layer is formed on an upper surface of the upper glass substrate, and, said pixel electrode layer is formed on a lower surface of the lower glass substrate.

8. The color filter substrate according to claim 1, further comprising a plurality of switch units configured to control on and off of the plurality of pixel electrodes.

9. The color filter substrate according to claim 8, wherein said switch unit comprises a thin film transistor.

10. The color filter substrate according to claim 1, wherein the electronic ink comprises black pigment particles and white pigment particles, and the black pigment particles are configured to move toward an observer to form a black matrix when a corresponding voltage is applied to the pixel electrodes.

11. A method of manufacturing a color filter substrate, comprising the following steps of:
providing a first glass substrate and forming a pattern of a common electrode layer on a surface of the first glass substrate;
providing a second glass substrate and forming a pattern of a color filter layer on a first surface of the second glass substrate, said color filter layer comprising a plurality of color filters with a void region therebetween;
forming a pattern of a plurality of pixel electrodes spaced from one another on a second surface of the second glass substrate opposite from the first surface such that a projection of the pattern of said plurality of pixel electrodes in a plane where said second surface is located is within a projection of the void region in the plane; and
forming, after forming the pattern of the plurality of pixel electrodes, a transparent photoresist pattern on the second surface of the second glass substrate, wherein said transparent photoresist pattern includes a plurality of transparent photoresist elements and a groove region between said plurality of transparent photoresist elements, a projection of each transparent photoresist element in the plane is overlapped with that of a corresponding color filter in the plane, and, a projection of the groove region in the plane is within or is fully overlapped with a projection of said void region in the plane;
filling, after forming the transparent photoresist pattern, said groove region with electronic ink; and
assembling, after filling of the electronic ink, the first glass substrate and the second glass substrate in such a manner that the surface of the first glass substrate formed with the common electrode layer seals and covers the electronic ink on the second glass substrate.

12. The method according to claim 11, wherein the step of forming the pattern of the plurality of pixel electrodes spaced from one another further comprises:
forming a plurality of switch units configured to control on and off of the plurality of pixel electrodes.

13. The method according to claim 12, wherein said switch unit comprises a thin film transistor.

14. The method according to claim 11, further comprising:
coating an outer coating on the pattern of the color filter layer.

15. The method according to claim 14, further comprising:
forming spacers on said outer coating.

16. The method according to claim 11, wherein said second glass substrate comprises an upper glass substrate having said first surface and a third surface and a lower glass substrate having said second surface and a fourth surface, and the method further comprises:
superposing, after forming the patterns on said first surface and said second surface, the upper glass substrate and the lower glass substrate with each other such that the third surface of the upper glass substrate are jointed to the fourth surface of the lower glass substrate.

17. The method according to claim 11, wherein the electronic ink is filled between the adjacent transparent photoresist elements by an inkjet technology.

18. A display device comprising a color filter substrate according to claim 1.
